(19) United States
(12) Patent Application Publication
(10) Pub. No.: US 2026/0261656 A1
(43) Pub. Date: Sep. 3, 2026

(54) RECONSTRUCTION BY BLENDING PREDICTION AND RESIDUAL

(71) Applicant: InterDigital Madison Patent Holdings, SAS, Paris (FR)

(72) Inventors: Edouard FRANCOIS, Cesson-Sevigne (FR); Ya CHEN, Cesson-Sevigne (FR); Karam NASER, Cesson-Sevigne (FR); Guillaume BOISSON, Cesson-Sevigne (FR)

(21) Appl. No.: 18/876,079

(22) PCT Filed: Jun. 22, 2023
(86) PCT No.: PCT/EP2023/067061

§ 371 Date: Dec. 17, 2024

(30) Foreign Application Priority Data
Jul. 1, 2022 (EP) 22305980.9

(51) Int. Cl. H04N 19/107; H04N 19/124; H04N 19/132; H04N 19/136; H04N 19/176; H04N 19/61

(52) U.S. Cl. CPC H04N 19/107; H04N 19/124; H04N 19/132; H04N 19/136; H04N 19/176; H04N 19/61

(57) ABSTRACT

In one implementation, the simple addition of the prediction sample block (Pred(p)) and the decoded residual sample block (Res p) in the reconstruction process is replaced by a blending process. The blending process can be considered as a function f(Pred(p), Res p) involving more complex operations than a simple addition. For example, the decoded prediction residuals (Resp) can be scaled by a scaling factor and/or shifted by an offset in the blending process. The prediction samples (Pred(p)) may also be scaled in the blending process. At the encoder side, the blending parameter(s) for a block may be selected by minimizing a loss function. At the decoder side, a set of blending parameters may be predefined or decoded, and a particular blending parameter can be selected by the decoder based on the prediction sample value, quantization parameter (QP) for the block or an index signaled for the current block.

### TECHNICAL FIELD

The present embodiments generally relate to a method and an apparatus for reconstruction in video encoding and decoding.

### BACKGROUND

To achieve high compression efficiency, image and video coding schemes usually employ prediction and transform to leverage spatial and temporal redundancy in the video content. Generally, intra or inter prediction is used to exploit the intra or inter picture correlation, then the differences between the original block and the predicted block, often denoted as prediction errors or prediction residuals, are transformed, quantized, and entropy coded. To reconstruct the video, the compressed data are decoded by inverse processes corresponding to the entropy coding, quantization, transform, and prediction.

### SUMMARY

According to one embodiment, a method of video decoding is presented, comprising: obtaining a first set of data corresponding to a prediction block for a block of a picture; obtaining a second set of data corresponding to decoded prediction residuals for said block of said picture; adjusting said second set of data to form an adjusted second set of data, based on at least a blending parameter; and combining said first set of data and said adjusted second set of data to form a decoded version of said block of said picture.

According to another embodiment, a method of video encoding is presented, comprising: obtaining a first set of data corresponding to a prediction block for a block of a picture; obtaining a second set of data corresponding to reconstructed prediction residuals for said block of said picture; adjusting said second set of data to form an adjusted second set of data, based on at least a blending parameter; and combining said first set of data and said adjusted second set of data to form a reconstructed version of said block of said picture.

According to another embodiment, an apparatus for video decoding is provided, comprising one or more processors and at least one memory coupled to said one or more processors, wherein said one or more processors are configured to: obtain a first set of data corresponding to a prediction block for a block of a picture; obtain a second set of data corresponding to decoded prediction residuals for said block of said picture; adjusting said second set of data to form an adjusted second set of data, based on at least a blending parameter; and combine said first set of data and said adjusted second set of data to form a decoded version of said block of said picture.

According to another embodiment, an apparatus for video encoding is provided, comprising one or more processors and at least one memory coupled to said one or more processors, wherein said one or more processors are configured to: obtain a first set of data corresponding to a prediction block for a block of a picture; obtain a second set of data corresponding to reconstructed prediction residuals for said block of said picture; adjust said second set of data to form an adjusted second set of data, based on at least a blending parameter; and combine said first set of data and said adjusted second set of data to form a reconstructed version of said block of said picture.

One or more embodiments also provide a computer program comprising instructions which when executed by one or more processors cause the one or more processors to perform the encoding method or decoding method according to any of the embodiments described herein. One or more of the present embodiments also provide a computer readable storage medium having stored thereon instructions for video encoding or decoding according to the methods described herein.

One or more embodiments also provide a computer readable storage medium having stored thereon video data generated according to the methods described above. One or more embodiments also provide a method and apparatus for transmitting or receiving the video data generated according to the methods described herein.

### BRIEF DESCRIPTION OF THE DRAWINGS

FIG. 1 illustrates a block diagram of a system within which aspects of the present embodiments may be implemented.

FIG. 2 illustrates a block diagram of an embodiment of a video encoder.

FIG. 3 illustrates a block diagram of an embodiment of a video decoder.

FIG. 4 illustrates a block diagram of a video encoder that blends the decoded prediction residuals and prediction samples, according to an embodiment.

FIG. 5 illustrates a block diagram of a video decoder that blends the prediction residuals and prediction samples, according to an embodiment.

FIG. 6 illustrates a block diagram of a video encoder that blends the prediction residuals and prediction samples in the transform domain, according to an embodiment.

FIG. 7 illustrates a block diagram of a video decoder that blends the prediction residuals and prediction samples in the transform domain, according to an embodiment.

FIG. 8 illustrates a method of clipping when the blending is performed in the sample domain, according to an embodiment.

FIG. 9 illustrates a process of the blending process for a block to be encoded or decoded, according to an embodiment.

FIG. 10 illustrates a method of obtaining the blending parameter, according to an embodiment.

FIG. 11 illustrates a method of obtaining the blending parameter based on the quantization parameter, according to an embodiment.

FIG. 12 illustrates a method of obtaining the blending parameter based on the prediction sample, according to an embodiment.

### DETAILED DESCRIPTION

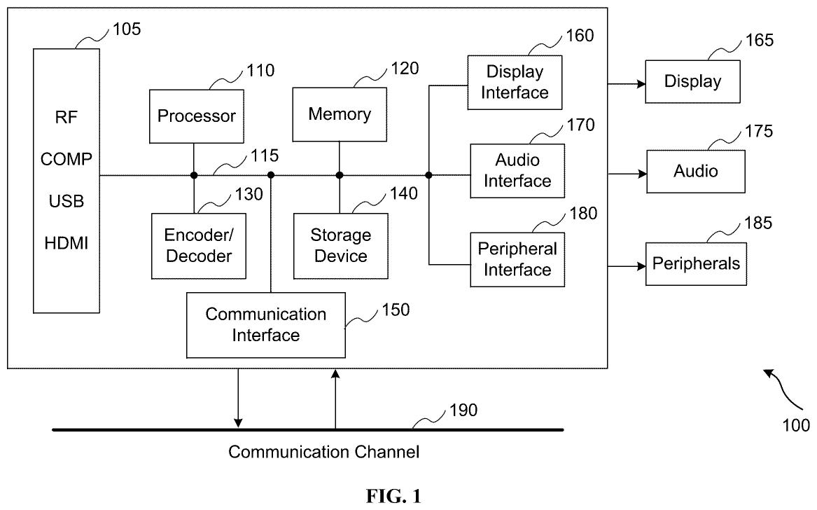

FIG. 1 illustrates a block diagram of an example of a system in which various aspects and embodiments can be implemented. System 100 may be embodied as a device including the various components described below and is configured to perform one or more of the aspects described in this application. Examples of such devices, include, but are not limited to, various electronic devices such as personal computers, laptop computers, smartphones, tablet computers, digital multimedia set top boxes, digital television receivers, personal video recording systems, connected home appliances, and servers. Elements of system 100, singly or in combination, may be embodied in a single integrated circuit, multiple ICs, and/or discrete components. For example, in at least one embodiment, the processing and encoder/decoder elements of system 100 are distributed across multiple ICs and/or discrete components. In various embodiments, the system 100 is communicatively coupled to other systems, or to other electronic devices, via, for example, a communications bus or through dedicated input and/or output ports. In various embodiments, the system 100 is configured to implement one or more of the aspects described in this application.

The system 100 includes at least one processor 110 configured to execute instructions loaded therein for implementing, for example, the various aspects described in this application. Processor 110 may include embedded memory, input output interface, and various other circuitries as known in the art. The system 100 includes at least one memory 120 (e.g., a volatile memory device, and/or a non-volatile memory device). System 100 includes a storage device 140, which may include non-volatile memory and/or volatile memory, including, but not limited to, EEPROM, ROM, PROM, RAM, DRAM, SRAM, flash, magnetic disk drive, and/or optical disk drive. The storage device 140 may include an internal storage device, an attached storage device, and/or a network accessible storage device, as non-limiting examples.

System 100 includes an encoder/decoder module 130 configured, for example, to process data to provide an encoded video or decoded video, and the encoder/decoder module 130 may include its own processor and memory. The encoder/decoder module 130 represents module(s) that may be included in a device to perform the encoding and/or decoding functions. As is known, a device may include one or both of the encoding and decoding modules. Additionally, encoder/decoder module 130 may be implemented as a separate element of system 100 or may be incorporated within processor 110 as a combination of hardware and software as known to those skilled in the art.

Program code to be loaded onto processor 110 or encoder/decoder 130 to perform the various aspects described in this application may be stored in storage device 140 and subsequently loaded onto memory 120 for execution by processor 110. In accordance with various embodiments, one or more of processor 110, memory 120, storage device 140, and encoder/decoder module 130 may store one or more of various items during the performance of the processes described in this application. Such stored items may include, but are not limited to, the input video, the decoded video or portions of the decoded video, the bitstream, matrices, variables, and intermediate or final results from the processing of equations, formulas, operations, and operational logic.

In several embodiments, memory inside of the processor 110 and/or the encoder/decoder module 130 is used to store instructions and to provide working memory for processing that is needed during encoding or decoding. In other embodiments, however, a memory external to the processing device (for example, the processing device may be either the processor 110 or the encoder/decoder module 130) is used for one or more of these functions. The external memory may be the memory 120 and/or the storage device 140, for example, a dynamic volatile memory and/or a non-volatile flash memory. In several embodiments, an external non-volatile flash memory is used to store the operating system of a television. In at least one embodiment, a fast external dynamic volatile memory such as a RAM is used as working memory for video coding and decoding operations, such as for MPEG-2, HEVC, or VVC.

The input to the elements of system 100 may be provided through various input devices as indicated in block 105. Such input devices include, but are not limited to, (i) an RF portion that receives an RF signal transmitted, for example, over the air by a broadcaster, (ii) a Composite input terminal, (iii) a USB input terminal, and/or (iv) an HDMI input terminal.

In various embodiments, the input devices of block 105 have associated respective input processing elements as known in the art. For example, the RF portion may be associated with elements suitable for (i) selecting a desired frequency (also referred to as selecting a signal, or band-limiting a signal to a band of frequencies), (ii) down converting the selected signal, (iii) band-limiting again to a narrower band of frequencies to select (for example) a signal frequency band which may be referred to as a channel in certain embodiments, (iv) demodulating the down converted and band-limited signal, (v) performing error correction, and (vi) demultiplexing to select the desired stream of data packets. The RF portion of various embodiments includes one or more elements to perform these functions, for example, frequency selectors, signal selectors, band-limiters, channel selectors, filters, downconverters, demodulators, error correctors, and demultiplexers. The RF portion may include a tuner that performs various of these functions, including, for example, down converting the received signal to a lower frequency (for example, an intermediate frequency or a near-baseband frequency) or to baseband. In one set-top box embodiment, the RF portion and its associated input processing element receives an RF signal transmitted over a wired (for example, cable) medium, and performs frequency selection by filtering, down converting, and filtering again to a desired frequency band. Various embodiments rearrange the order of the above-described (and other) elements, remove some of these elements, and/or add other elements performing similar or different functions. Adding elements may include inserting elements in between existing elements, for example, inserting amplifiers and an analog-to-digital converter. In various embodiments, the RF portion includes an antenna.

Additionally, the USB and/or HDMI terminals may include respective interface processors for connecting system 100 to other electronic devices across USB and/or HDMI connections. It is to be understood that various aspects of input processing, for example, Reed-Solomon error correction, may be implemented, for example, within a separate input processing IC or within processor 110 as necessary. Similarly, aspects of USB or HDMI interface processing may be implemented within separate interface ICs or within processor 110 as necessary. The demodulated, error corrected, and demultiplexed stream is provided to various processing elements, including, for example, processor 110, and encoder/decoder 130 operating in combination with the memory and storage elements to process the datastream as necessary for presentation on an output device.

Various elements of system 100 may be provided within an integrated housing, Within the integrated housing, the various elements may be interconnected and transmit data therebetween using suitable connection arrangement 115, for example, an internal bus as known in the art, including the I2C bus, wiring, and printed circuit boards.

The system 100 includes communication interface 150 that enables communication with other devices via communication channel 190. The communication interface 150 may include, but is not limited to, a transceiver configured to transmit and to receive data over communication channel 190. The communication interface 150 may include, but is not limited to, a modem or network card and the communication channel 190 may be implemented, for example, within a wired and/or a wireless medium.

Data is streamed to the system 100, in various embodiments, using a Wi-Fi network such as IEEE 802.11. The Wi-Fi signal of these embodiments is received over the communications channel 190 and the communications interface 150 which are adapted for Wi-Fi communications. The communications channel 190 of these embodiments is typically connected to an access point or router that provides access to outside networks including the Internet for allowing streaming applications and other over-the-top communications. Other embodiments provide streamed data to the system 100 using a set-top box that delivers the data over the HDMI connection of the input block 105. Still other embodiments provide streamed data to the system 100 using the RF connection of the input block 105.

The system 100 may provide an output signal to various output devices, including a display 165, speakers 175, and other peripheral devices 185. The other peripheral devices 185 include, in various examples of embodiments, one or more of a stand-alone DVR, a disk player, a stereo system, a lighting system, and other devices that provide a function based on the output of the system 100. In various embodiments, control signals are communicated between the system 100 and the display 165, speakers 175, or other peripheral devices 185 using signaling such as AV. Link, CEC, or other communications protocols that enable device-to-device control with or without user intervention. The output devices may be communicatively coupled to system 100 via dedicated connections through respective interfaces 160, 170, and 180. Alternatively, the output devices may be connected to system 100 using the communications channel 190 via the communications interface 150. The display 165 and speakers 175 may be integrated in a single unit with the other components of system 100 in an electronic device, for example, a television. In various embodiments, the display interface 160 includes a display driver, for example, a timing controller (T Con) chip.

The display 165 and speaker 175 may alternatively be separate from one or more of the other components, for example, if the RF portion of input 105 is part of a separate set-top box. In various embodiments in which the display 165 and speakers 175 are external components, the output signal may be provided via dedicated output connections, including, for example, HDMI ports, USB ports, or COMP outputs.

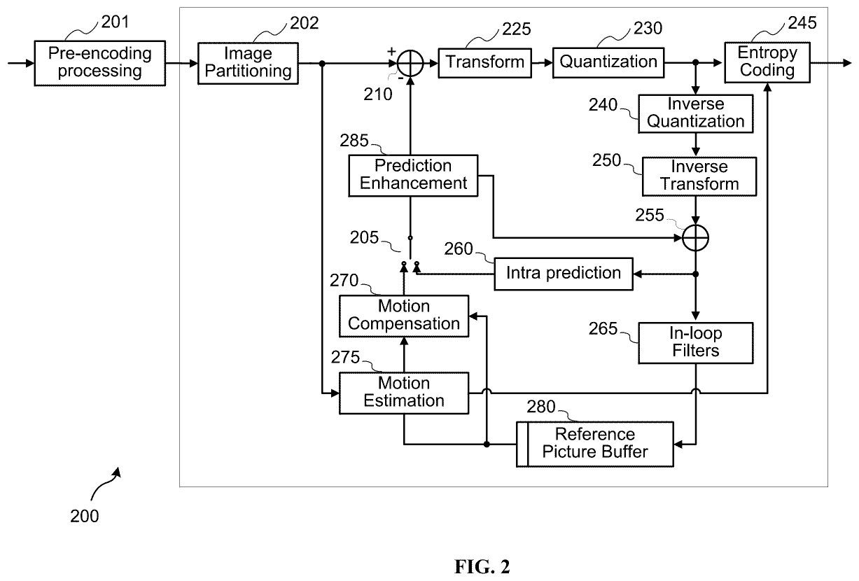

FIG. 2 illustrates an example video encoder 200, such as a VVC (Versatile Video Coding) encoder. FIG. 2 may also illustrate an encoder in which improvements are made to the VVC standard or an encoder employing technologies similar to VVC.

In the present application, the terms “reconstructed” and “decoded” may be used interchangeably, the terms “encoded” or “coded” may be used interchangeably, and the terms “image,” “picture” and “frame” may be used interchangeably. Usually, but not necessarily, the term “reconstructed” is used at the encoder side while “decoded” is used at the decoder side.

Before being encoded, the video sequence may go through pre-encoding processing (201), for example, applying a color transform to the input color picture (e.g., conversion from RGB 4:4:4 to YCbCr 4:2:0), or performing a remapping of the input picture components in order to get a signal distribution more resilient to compression (for instance using a histogram equalization of one of the color components). Metadata can be associated with the pre-processing, and attached to the bitstream.

In the encoder 200, a picture is encoded by the encoder elements as described below. The picture to be encoded is partitioned (202) and processed in units of, for example, CUs. Each unit is encoded using, for example, either an intra or inter mode. When a unit is encoded in an intra mode, it performs intra prediction (260). In an inter mode, motion estimation (275) and compensation (270) are performed. The encoder decides (205) which one of the intra mode or inter mode to use for encoding the unit, and indicates the intra/inter decision by, for example, a prediction mode flag. After prediction, prediction enhancement (285) is applied to the prediction block. Prediction residuals are calculated, for example, by subtracting (210) the predicted block from the original image block.

The prediction residuals are then transformed (225) and quantized (230). The quantized transform coefficients, as well as motion vectors and other syntax elements, are entropy coded (245) to output a bitstream. The encoder can skip the transform and apply quantization directly to the non-transformed residual signal. The encoder can bypass both transform and quantization, i. e., the residual is coded directly without the application of the transform or quantization processes.

The encoder decodes an encoded block to provide a reference for further predictions. The quantized transform coefficients are de-quantized (240) and inverse transformed (250) to decode prediction residuals. Combining (255) the decoded prediction residuals and the predicted block, an image block is reconstructed. In-loop filters (265) are applied to the reconstructed picture to perform, for example, deblocking/SAO (Sample Adaptive Offset) filtering to reduce encoding artifacts. The filtered image is stored at a reference picture buffer (280).

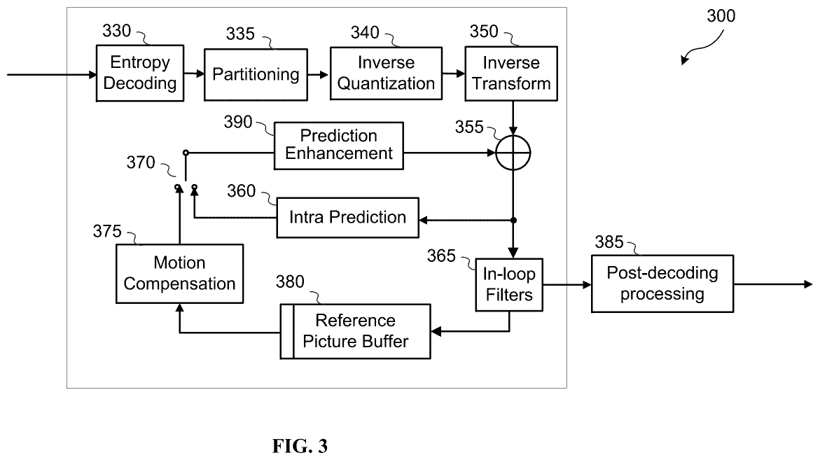

FIG. 3 illustrates a block diagram of an example video decoder 300. In the decoder 300, a bitstream is decoded by the decoder elements as described below. Video decoder 300 generally performs a decoding pass reciprocal to the encoding pass as described in FIG. 2. The encoder 200 also generally performs video decoding as part of encoding video data.

In particular, the input of the decoder includes a video bitstream, which can be generated by video encoder 200. The bitstream is first entropy decoded (330) to obtain transform coefficients, motion vectors, and other coded information. The picture partition information indicates how the picture is partitioned. The decoder may therefore divide (335) the picture according to the decoded picture partitioning information. The transform coefficients are de-quantized (340) and inverse transformed (350) to decode the prediction residuals. Combining (355) the decoded prediction residuals and the predicted block, an image block is reconstructed. The predicted block can be obtained (370) from intra prediction (360) or motion-compensated prediction (i.e., inter prediction) (375). After prediction, prediction enhancement (390) is applied to the prediction block. In-loop filters (365) are applied to the reconstructed image. The filtered image is stored at a reference picture buffer (380).

The decoded picture can further go through post-decoding processing (385), for example, an inverse color transform (e.g., conversion from YCbCr 4:2:0 to RGB 4:4:4) or an inverse remapping performing the inverse of the remapping process performed in the pre-encoding processing (201). The post-decoding processing can use metadata derived in the pre-encoding processing and signaled in the bitstream.

The proposed methods relate to the reconstruction step, corresponding to the addition step (255 at encoder side in FIG. 2, 355 at decoder side in FIG. 3). In usual video coding standards or consortium solutions such as AVC, HEVC, VVC, and AV1, this reconstruction step consists for samples of a given block B in adding the decoded prediction residual samples Res′(p) (also named residue), resulting from the inverse transform step (250, 350), to the prediction samples Pred(p), resulting from the prediction step (205, 370) when there is no prediction enhancement or from the prediction enhancement step (285, 390), to obtain the reconstructed samples Rec(p), for each sample location p in the block.

$$Rec ( p ) = Pred ( p ) + {Res}^{′} ( p ) \qquad Equation 1$$

The residual samples Res(p) of a transform block are obtained at the encoder side by computing the difference between the original samples Orig(p) and the prediction samples Pred(p). The resulting difference samples are then processed by the transform, then quantization. To reconstruct the block, the encoder then performs de-quantization and inverse transform. The output is a block of decoded prediction residual samples Res′(p), which represent the sample differences corrupted by quantization noise Err(p).

$${Res}^{′} ( p ) = Orig ( p ) - P r e d ( p ) + E r r ( p ) \qquad Equation 2$$

The reconstruction step does not consider this error (Err(p)), or correct it. Further in-loop filtering steps are intended to fix the issue, but it is relevant to also try to reduce the error in the reconstruction step itself.

In this document, we propose to replace the simple addition of the prediction sample block and the decoded prediction residual samples block in the reconstruction step, by a blending process. The blending process is considered as a function f(Pred(p), Res′(p)) involving more complex operations than a simple addition.

### Replacing Addition by a Blending Process for Deriving Reconstruction Samples

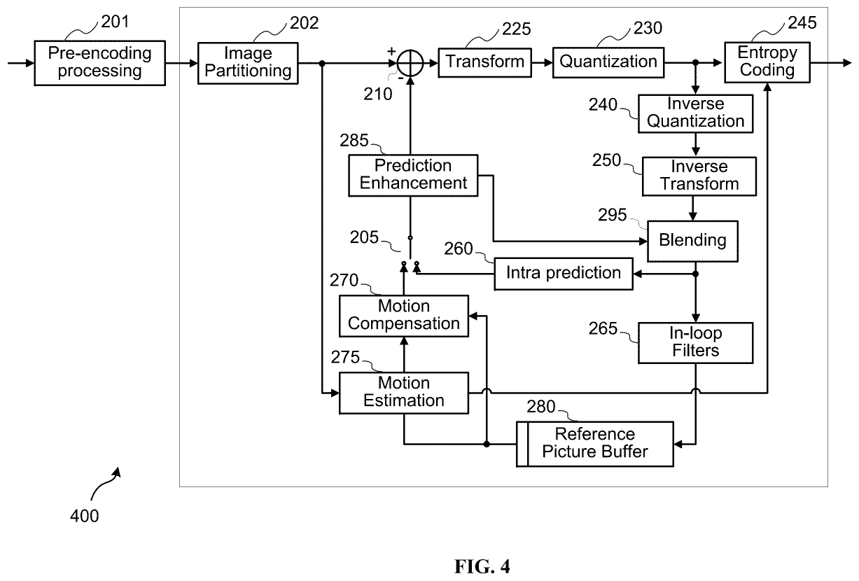

FIG. 4 illustrates a modified encoder scheme (400), according to an embodiment. In particular, the addition step (255) is replaced by a blending step (295) that is more complex than a simple addition of prediction and decoded prediction residual samples.

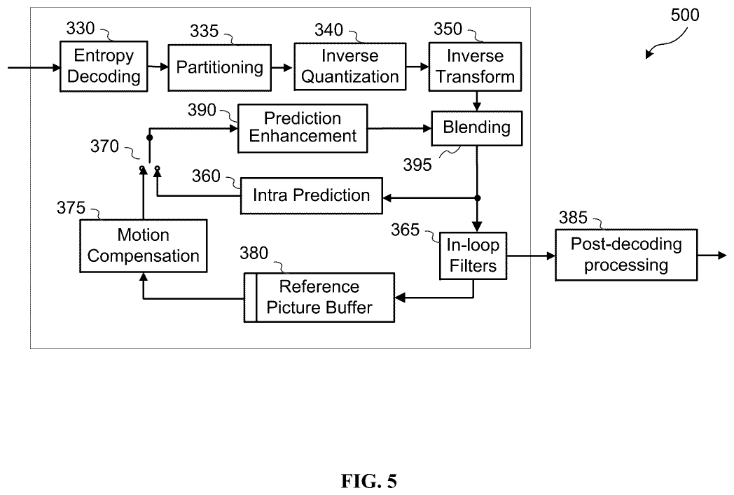

FIG. 5 illustrates a modified decoder scheme (500), according to an embodiment. In particular, the addition step (355) is replaced by a blending step (395) that is more complex than a simple addition of prediction and decoded prediction residual samples.

The blending steps at the encoder and decoder sides (295, 395) perform identically. The blending process of the prediction block with the residual block generates the reconstruction samples based on a blending function

$$Rec ( p ) = f ( P r e d ( p ) , {Res}^{′} ( p ) ) for all locations p in the block \qquad Equation 3$$

where f(a,b) is different from a simple addition. The function may also depend on the sample location p. Different implementations of the function f(·) are described in the following.

### Scaling Correction of Decoded Prediction Residual Samples

In a first embodiment, the blending process performs the following operation for the samples of the block:

$$Rec ( p ) = Pred ( p ) + β ( p ) * {Res}^{′} ( p ) \qquad Equation 4$$

where β(p) is a weighting factor (scaling factor) applied to the decoded prediction residual sample, allowing to correct the quantization error of the residue. The value of β(p) is logically constrained to be close to 1, in the interval I=[1−d, 1+d], for instance d=0.1, because Res′(p) is expected to be close to the real (non-quantized) difference value Res(p)(Orig(p)-Pred(p)). More generally, the constraint interval can be I=[1−d1, 1+d2] where d1 and d2 can take the same or different values.

In an example, the range of the interval depends on the quantization parameter QP used for quantizing the block residual: I=[1−d(QP), 1+d(QP)], where 2*d(QP) is the range of the interval.

Equation 4 is written in floating-point format. But in practice, a fixed-point operation would be used in real implementation. For instance, Equation 4 can be implemented as follows:

$$Rec ( p ) = Pred ( p ) + ( β ( p ) * {Res}^{′} ( p ) + md\_offset ) >> K \qquad Equation 5$$

where β(p) is a fixed-point value, K is a pre-defined fixed-point value, and the operator >>corresponds to right shift that moves the bit value of a binary value, rnd_offset is a fixed rounding offset, for instance equal to 2^{K-1}.

For notation simplifications, in the following equations, the sample location dependency “(p)” is removed when it is not necessary.

Derivation of Blending Parameter from Neighboring Samples

The inference of β(p) (at encoder and decoder) can be based on neighboring reconstructed samples Rec, prediction samples and decoded prediction residual samples, for instance N top rows and left columns of neighboring samples of the current block, N being for instance equal to 4.

For instance, the values of β for the different reconstructed sample values can be estimated from neighboring samples (in neighboring area v causal to the current block), knowing that the reconstructed neighboring samples follow Equation 4.

The sample range [0-1023] for a 10-bit signal can be divided in P non-overlapping intervals I₁ . . . I_{P}. The intervals can be of equal length (1024/P for a 10-bit signal). Examples of P values are 16 (with interval length 64) or 8 (with interval length 128) to reduce complexity. For each interval Iₖ, k=1 . . . P, the following can be applied. For all position p in neighboring area v, derive βₖ from all p such that for Pred(p) is in Iₖ, for instance minimizing mean square error (MSE):

$${β}_{k} = arg {min}_{b} {\sum }_{p i n ν / Pred ( p ) i n {I}_{k}} {( R e c ( p ) - Pred ( p ) - b * {Res}^{′} ( p ) )}^{2} \qquad Equation 6$$

This value of βₖ will then be used in the current block for all samples whose prediction sample value Pred(p) is in Iₖ. For all p of the current block whose prediction sample value Pred(p) is in Iₖ

$$Rec ( p ) = Pred ( p ) + {β}_{k} ( p ) * {Res}^{′} ( p ) \qquad Equation 7$$

Each position in the current block (noted Blk) has therefore a value β(p) corresponding to βₖ(p), where k is the index of the interval to which Pred(p) belongs.

In another example, to simplify the blending parameter derivation, a single value β will be applied on all samples in the current block (P=1), rather than several piece-wise (interval-dependent) values. Similar to aforementioned, derive β from all position p in neighboring area v, for instance minimizing MSE:

$$β = arg {min}_{b} {\sum }_{p i n ν} {( R e c ( p ) - Pred ( p ) - b * {Res}^{′} ( p ) )}^{2} \qquad Equation 8$$

In another example, to further simplify the blending parameter derivation, a single value β_{QP} will be applied on all samples quantized with the same QP value, rather than several values for different blocks. All the preceding reconstructed samples (or could also be limited in some neighboring area v), which are quantized with the same QP, are used to derive Bop, for instance minimizing MSE:

$${β}_{Q P} = arg {min}_{b} {\sum }_{p quantized with QP} {( Rec ( P ) - P r e d ( P ) - b * {Res}^{′} ( P ) )}^{2} \qquad Equation 9$$

Each position in the current block (noted Blk) has therefore a value β(p) corresponding to β_{QP}(p), where QP is the quantization parameter applied to the block that contains the sample at location p.

In the above, the blending parameters (β, βₖ, β_{QP}) are derived with loss function MSE (L2-norm). Other loss functions can also be used, such as mean absolute error (MAE, L1-norm), or Huber loss function (for small errors, it behaves like MSE, but for large errors, it behaves like MAE, tuned by a hyperparameter δ, which could be related to the QP value).

### Using Regularization Terms

In an example, a regularization term is used (added) to constrain βₖ(p) to be close to those of its neighbors, belonging to a neighborhood V(p) of the pixel location p.

For instance, βₖ is computed to minimize the following function:

$${β}_{k} = arg {min}_{b} {\sum }_{p i n ν / Pred ( p ) i n {I}_{k}} {( R e c ( p ) - Pred ( p ) - b * {Res}^{′} ( p ) )}^{2} + λ {\sum }_{p i n Blk / Pred ( p ) i n {I}_{k}} {\sum }_{q i n V ( p )} {( b - β ( q ) )}^{2} \qquad Equation 10$$

where λ is a pre-defined regularization parameter. It can be fixed or depend on the QP parameter, or on the value of Pred(p). This typically leads to least mean square minimization as all terms in the equation involve square functions of β. Note that this may require several iterations, as in this equation the values β(q) are considered as fixed. For instance, a first iteration applies without the regularization term (λ=0). This leads to a first estimation of β(p), for any p in the Block. The next iterations apply with the regularization term. The process stops after a given number of iterations (for instance 3), or when the variations of β(p) become small. When the blending parameter is derived per QP, this may lead to

$${β}_{QP} = arg {min}_{b} {\sum }_{p quantized with QP} {( Rec ( p ) - Pred ( p ) - b * {Res}^{′} ( p ) )}^{2} + λ {\sum }_{p i n Blk quantized with QP} {\sum }_{q i n V ( p )} {( b - β ( q ) )}^{2} \qquad Equation 11$$

As in the previous case, this may require several iterations, as in this equation the values β(q) are considered as fixed. For instance, a first iteration applies without the regularization term (λ=0). This leads to a first estimation of β(p), for any p in the Block. The next iterations apply with the regularization term. The process stops after a given number of iterations (for instance 3), or when the variations of β(p) become small.

Alternatively, the regularization applies after a first estimation step that is based on equation 6 or equation 9. After this first estimation step, in the block, in each location p in the block, an estimated β(p) is available. A second step is then applied to regularize (smooth) the β(p) values, for example by simply applying a low-pass filter to the block of β(p) values.

The regularization term can also be related to the a priori probability of the signal Proba(rec=r). For instance, this probability can be computed from previously coded frames. In an embodiment, it is computed from previously coded frames of the same temporal ID. Alternatively, it can be coded once per scene cut, per intra picture, per gop (Group of Pictures), or per intra slice. The probability values can be provided in the shape of a histogram H(x) covering the signal range (for instance x is in 0, . . . , 1023 for a 10-bit signal). Alternatively, it can be modeled by a parametric function (e.g., polynomial), or a piece-wise parametric function.

Referring to Equation 8 or Equation 10, the regularization term can consist in adding a term proportional to:

$$- log ( Proba ( Rec ( p ) )$$

that is proportional to:

$$- log ( Proba ( Pred ( p ) + β ( p ) * {Res}^{′} ( p ) ) )$$

This regularization term constrains β(p) to tend to maximize this probability.

### Signaling Blending Parameters

An additional syntax element (for example a flag) can be transmitted for each block (TU, CU, or CTU), to indicate if the proposed blending is to be used for that particular block rather than a simple addition. The syntax element can be binary or non-binary when several blending models are used. For instance, a 1-bit syntax element is used when using a single piece-wise model (P=1), a 8-bit syntax element when using 8 piece-wise model (P=8), a 16-bit syntax element when using 16 piece-wise model (P=16). In a variant, blending parameters can be explicitly coded and transmitted for each applied block.

As described above, the value of β should logically be constrained to be close to 1, for example, in an interval I=[1−d, 1+d]. To signal the blending parameters, many bits may be needed to code these blending parameters. Also, the computational complexity in the encoder could be rather high. To limit the bit cost and computational complexity, in one example, the blending parameter β can only be chosen from a pre-defined set with M values, for instance M=4 or 8. In this case, only the corresponding index is needed to be inferred, or coded and transmitted. The number of possible blending parameters in the pre-defined set M could also depend on the slice type. For these possible blending parameter values, they could be varied and adapted to different QPs or contents via some offline learning.

If the value of β is signaled, it shall be estimated at encoder side before being signalled. This can be done by rate-distortion optimization, where the distortion is for instance estimated as:

$${\sum }_{p i n Blk} {( Orig ( p ) - P r e d ( p ) - β ( p ) * {Res}^{′} ( p ) )}^{2}$$

In the above, the decoded prediction residuals are scaled and then added to the prediction samples in the blending process. Other forms of blending functions can also be used.

In one example, the decoded prediction residual Res′(p) is adjusted by an offset:

$$Rec ( p ) = Pred ( p ) + ( {Res}^{′} ( p ) + b ( p ) ) \qquad Equation 11$$

In another example, the decoded prediction residual Res′(p) is scaled by a scaling factor and adjusted by an offset:

$$Rec ( p ) = Pred ( p ) + a ( p ) * {Res}^{′} ( p ) + b ( p ) \qquad Equation 12$$

In yet another example, the prediction sample Pred(p) is also scaled by a scaling factor a(p):

$$Rec ( p ) = a ( p ) * Pred ( p ) + b ( p ) * {Res}^{′} ( p ) + c ( p ) \qquad Equation 13$$

### Blending in the Transform Domain

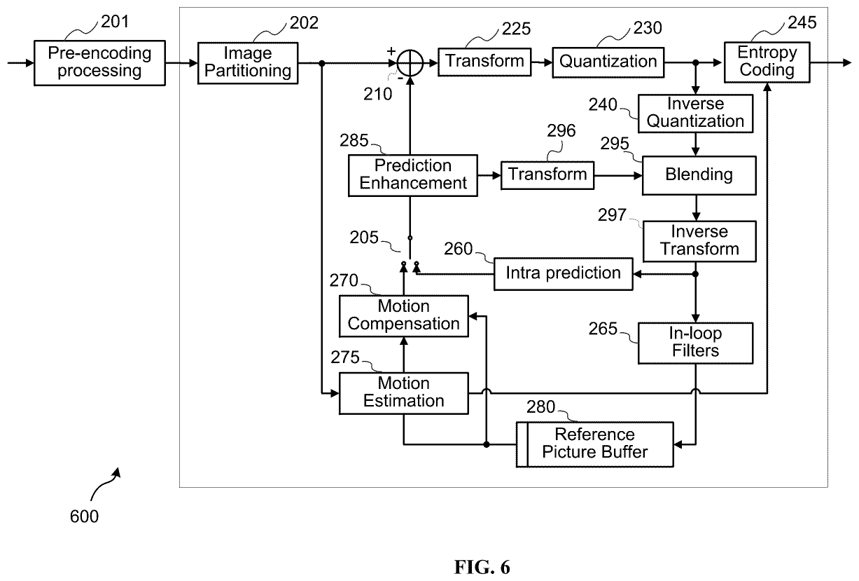

In another embodiment, the blending is performed in the transform domain. At the encoder (600), as depicted in FIG. 6, a new transform step (296) applied to the prediction signal, is inserted after the prediction enhancement step (285). The blending step (295) is applied after inverse quantization (240) and uses the output of the new transform step (296). The output of the blending step (295) is processed by the inverse transform step (297), to go back to the pixel domain.

In VVC, the transform process is made of two steps, MTS (Multi-Transform Selection) followed by LFNST (Low-Frequency Non-Separable Transform). MTS is made of a set of multiple transforms, and for a transform unit (TU), one transform from the set is selected (either signaled or inferred). At the encoder side, once the transform from MTS has been applied to prediction residual, a secondary transform, LFNST, can apply. At the decoder side, the inverse transform applies the inverse process, that is, inverse LFNST followed by inverse transform from MTS.

The MTS transform matrix used in 296 must be the same as the one used in step 225 (same MTS transform size, same MTS transform matrix coefficients). In an embodiment, both the MTS transform and LFNST are applied (when LFNST is activated for the TU) in 296. In another embodiment, only the MTS transform is applied in step 296. In this case, in order to be in the same transform domain, an additional inverse LFNST step should be applied between inverse quantization (240) before blending step (295).

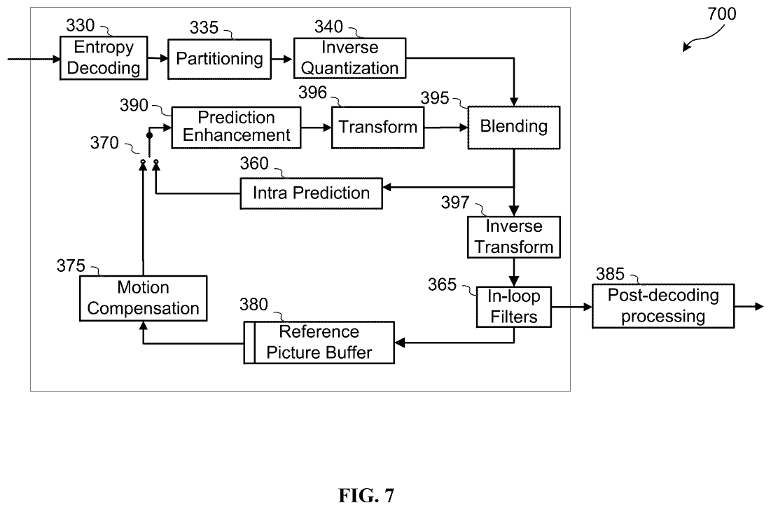

At the decoder (700), as depicted in FIG. 7, a new transform step (396) applied to the prediction signal is inserted after the prediction enhancement step (390). The blending step (395) is applied after inverse quantization (340) and uses the output of the new transform step (396). The output of the blending step (395) is processed by the inverse transform step (397), to go back to the pixel domain. It should be noted that the blending is now applied to the de-quantized transform coefficients before inverse transform, that is, the decoded prediction residual samples in the transform domain. Similar to the blending in the sample domain (see FIG. 4 and FIG. 5), the de-quantized transform coefficients can be scaled and/or shifted by an offset when combined with the (scaled) transformed prediction samples.

The MTS transform matrix 396 must be the same as the one used in steps 296 and 225. The inverse MTS transform matrix 397 must be the same as the one used in step 297. In an embodiment, both the MTS transform and LFNST are applied (when LFNST is activated for the TU) in 396. In another embodiment, only the MTS transform is applied in step 396. In this case, in order to be in the same transform domain, an inverse LFNST step should be applied between inverse quantization (340) and blending step (395).

When the blending process is applied in the transform domain, the adjustment (scaling or offset) of the de-quantized prediction residuals can be seen as refinement of the de-quantized prediction residuals, or the adjustment in the blending process can be seen as an additional step of the de-quantization process. The blending process makes it possible to reduce the distortion caused by quantization. That is, rather than performing de-quantization passively based on the parameters designed for quantization, now the de-quantization works more actively to reduce the distortion.

The advantage of working in the transform domain is that the quantization interval is perfectly known for each quantized coefficient. This interval is defined from the quantization parameter, that controls the quantization step. The quantization step is linearly dependent on the scaling factor “Is[x][y]”, for example, as derived in equations 1141 and 1142 of the VVC specification (ITU-T H.266, SERIES H: AUDIOVISUAL AND MULTIMEDIA SYSTEMS, Infrastructure of audiovisual services-Coding of moving video, Versatile Video Coding, 08/2020). The inverse quantization of a decoded coefficient dz[x][y] to obtain the inverse quantized coefficient dnc[x][y] is achieved by the equation (1145) of the VVC specification:

$$d n c [ x ] [ y ] = dz [ x ] [ y ] * ls [ x ] [ y ] + bdOffset ) >> bdShift \qquad Equation 14$$

where bdOffset and bdShift are parameters depending on the bit-depth of the signal.

Therefore it is expected that the original coefficient coef[x][y] is in the interval

$$Iorig = [ d n c [ x ] [ y ] - Delta / 2 ; d n c [ x ] [ y ] + Delta / 2 ] \qquad Equation 15$$

$$with$$

$$Delta = ( ls [ x ] [ y ] >> bdShift ) \qquad Equation 16$$

This property can be used to constrain the blending process. Typically, this means that the original coefficient (in transform domain) is inside this interval, with an equi-probability for all values inside this interval.

$$P ( coef = r ) = \{ \begin{matrix}\frac{1}{Delta} ; & for any r inside Iorig \\ 0 ; & for any r outside Iorig\end{matrix} \qquad Equation 17$$

### Clipping in the Transform Domain

The constraint of Equation 15 can be used for performing a clipping in the transform domain. If the blending process is performed in the transform domain, steps 295 and 395, with the inputs of the blending process being the transform coefficient of the prediction signal (Cpred[x][y]) and the inverse quantized residual coefficient (Cres′[x][y]), and the output from the blending process being cf=Crec′[x][y], cf shall belong to the interval [Crec[x][y]−Delta/2, Crec[x][y]+Delta/2] where Crec[x][y]=Cpred[x][y]+Cres′[x][y], which means that cf can be clipped according to the following equation:

$$cf = Clip 3 ( Crec [ x ] [ y ] - Delta / 2 , Crec [ x ] [ y ] + Delta / 2 , cf ) , with$$

$$Clip 3 ( x , y , z ) = \{ \begin{matrix}x ; & z < x \\ y ; & z > y \\ z ; & otherwise\end{matrix}$$

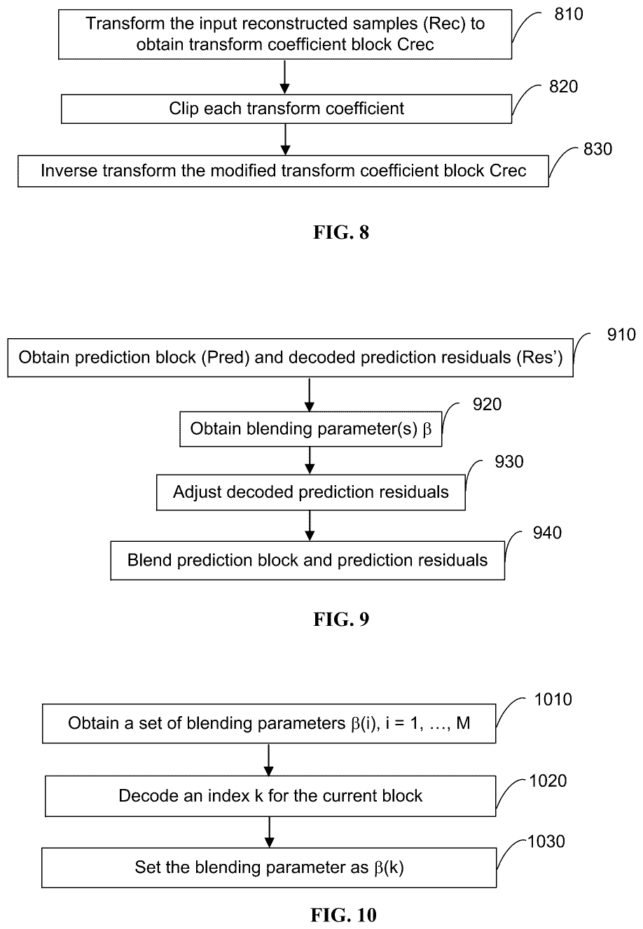

If the blending process is performed in the sample domain (not in the transform domain), as illustrated in FIG. 4 or FIG. 5, the clipping process shall follow the following steps, as illustrated in FIG. 8:
Apply transform to the input reconstructed samples block Rec′ obtained after the blending process, to obtain the transform coefficients block Crec′, and to the prediction samples block Pred, to obtain the transform coefficients block Cpred (step 810). The transform must be the same as the one used in steps 225, 296, 396.

$$Crec ’ = transform ( Rec ’ ) ;$$

$$Cpred = transform ( Pred ) ;$$

Clip each coefficient cf=Crec′[x][y] according to the following equations (step 820):

$$cf = Clip 3 ( Crec [ x ] [ y ] - Delta / 2 , C r e c [ x ] [ y ] + Delta / 2 , cf )$$

where Crec[x][y]=Cpred[x][y]+Cres′[x][y], Cres′[x][y] being the inverse quantized residual coefficient,
Crec′[x][y] is then modified as cf: Crec′[x][y]=cf.
Apply inverse transform to the modified transform coefficients block Crec′, to obtain the modified reconstructed samples block Rec (830). The inverse transform must be the same as the one used in steps 250, 350, 297, 397.

$$Rec ’ = inverse\_transform ( Crec ’ ) .$$

### Case of Transform Skip

When the transform is skipped (from an encoder decision), the residual of each sample is in the quantization interval defined by [−Delta/2; Delta/2]. This property can be used to constrain the blending process. Typically, this means that the original sample (in sample domain) is inside this interval, with an equi-probability for all values inside this interval.

$$P ( sample = r ) = \{ \begin{matrix}\frac{1}{Delta} ; & for any r inside Iorig \\ 0 ; & for any r outside Iorig\end{matrix} \qquad Equation 18$$

Alternatively, when transform skip applies, a clipping process can also apply directly in the sample domain, after any step following steps 255 and 355, or 295 and 395. With the inputs of the blending process being the prediction signal (Pred[x][y]) and the inverse quantized residual coefficient Res′[x][y], and the output from the blending process being R=Rec′[x][y], R shall belong to the interval [Rec[x][y]−Delta/2, Rec[x][y]+Delta/2], where Rec[x][y]=Pred[x][y]+Res′[x][y], which means that R can be clipped according to the following equation:

$$R = Clip 3 ( Rec [ x ] [ y ] - Delta / 2 , Rec [ x ] [ y ] + Delta / 2 , R ) .$$

FIG. 9 illustrates a blending process in the sample domain for a block to be encoded or decoded, according to an embodiment. The encoder or decoder can obtain (910) a prediction block from intra or inter prediction, with or without prediction refinement. The decoded prediction residuals (Res′) are also obtained (910), for example, after de-quantizing and inverse transforming the transform coefficients. The blending parameter(s) for the block is obtained at 920. As described before, a blending parameter may be a scaling factor to scale (930) the prediction residuals or an offset to adjust (930) the prediction residuals. At the encoder side, the blending parameter(s) can be obtained, for example, as described in Equations 6-10, to minimize a loss function. At the decoder side, for example, a set of parameters may be pre-defined or decoded, and a particular blending parameter is selected for the block from the set of parameters. The prediction block and the decoded prediction residuals can then be combined (940), for example, as described in Equations 11-13.

FIG. 10 illustrates a method of obtaining the blending parameter, according to an embodiment. In this embodiment, at step 1010, a set of blending parameters, β(i), i=1, . . . , M are obtained, for example, decoded from the bitstream or pre-defined at the decoder for a slice or picture. At step 1020, the decoder decodes a syntax element that defines an index k into the set of blending parameters for the current block. At step 1030, the blending parameter is set as β(k).

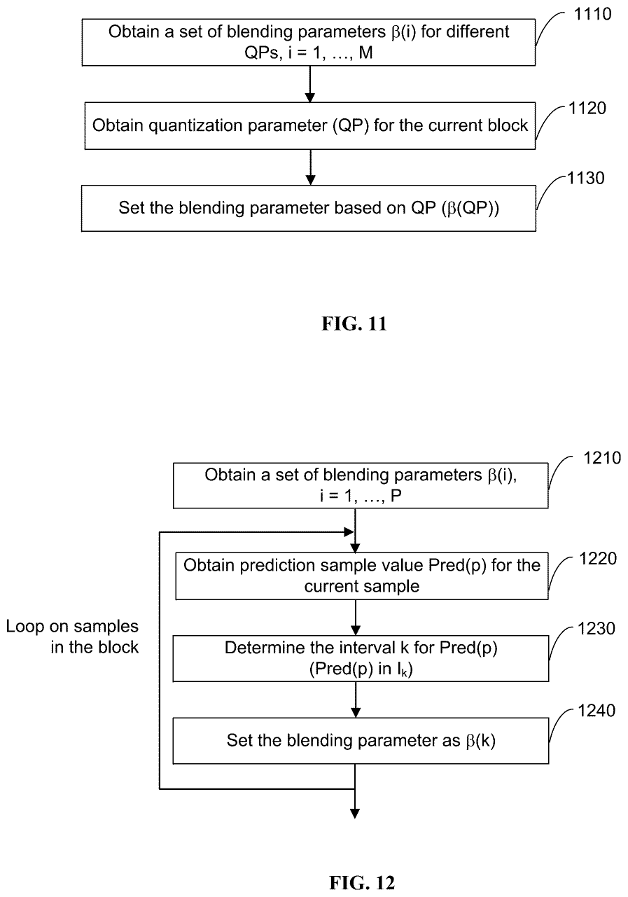

FIG. 11 illustrates another method of obtaining the blending parameter, according to an embodiment. In this embodiment, at step 1110, a set of blending parameters, β(i), i=1, . . . , M are obtained, for example, decoded from the bitstream or pre-defined at the decoder for a slice or picture. Each blending parameter in the set corresponds to a different QP. At step 1120, the decoder obtains the quantization parameter QP for the current block. At step 1130, the blending parameter is set as the blending parameter corresponding to the QP (e.g., β(QP)).

FIG. 12 illustrates another method of obtaining the blending parameter, according to an embodiment. In this embodiment, at step 1210, a set of blending parameters, β(i), i=1, . . . , P are obtained, for example, decoded from the bitstream or pre-defined at the decoder for a slice or picture. Each blending parameter in the set corresponds to a sample value interval. The decoder loops through every sample in the current block. At step 1220, the decoder obtains the sample value Pred(p) for the current sample. At step 1230, the decoder determines the interval k for Pred(p) (i.e., the sample value Pred(p) belongs to interval k). At step 1240, the blending parameter is set as the blending parameter β(k).

Various methods are described herein, and each of the methods comprises one or more steps or actions for achieving the described method. Unless a specific order of steps or actions is required for proper operation of the method, the order and/or use of specific steps and/or actions may be modified or combined. Additionally, terms such as “first”, “second”, etc. may be used in various embodiments to modify an element, component, step, operation, etc., for example, a “first decoding” and a “second decoding”. Use of such terms does not imply an ordering to the modified operations unless specifically required. So, in this example, the first decoding need not be performed before the second decoding, and may occur, for example, before, during, or in an overlapping time period with the second decoding.

Various methods and other aspects described in this application can be used to modify modules, for example, the reconstruction modules (255, 355), of a video encoder 200 and decoder 300 as shown in FIG. 2 and FIG. 3. Moreover, the present aspects are not limited to VVC or HEVC, and can be applied, for example, to other standards and recommendations, and extensions of any such standards and recommendations. Unless indicated otherwise, or technically precluded, the aspects described in this application can be used individually or in combination.

Various numeric values are used in the present application. The specific values are for example purposes and the aspects described are not limited to these specific values.

Various implementations involve decoding. “Decoding,” as used in this application, may encompass all or part of the processes performed, for example, on a received encoded sequence in order to produce a final output suitable for display. In various embodiments, such processes include one or more of the processes typically performed by a decoder, for example, entropy decoding, inverse quantization, inverse transformation, and differential decoding. Whether the phrase “decoding process” is intended to refer specifically to a subset of operations or generally to the broader decoding process will be clear based on the context of the specific descriptions and is believed to be well understood by those skilled in the art.

Various implementations involve encoding. In an analogous way to the above discussion about “decoding”, “encoding” as used in this application may encompass all or part of the processes performed, for example, on an input video sequence in order to produce an encoded bitstream.

Note that the syntax elements as used herein are descriptive terms. As such, they do not preclude the use of other syntax element names.

The implementations and aspects described herein may be implemented in, for example, a method or a process, an apparatus, a software program, a data stream, or a signal. Even if only discussed in the context of a single form of implementation (for example, discussed only as a method), the implementation of features discussed may also be implemented in other forms (for example, an apparatus or program). An apparatus may be implemented in, for example, appropriate hardware, software, and firmware. The methods may be implemented in, for example, an apparatus, for example, a processor, which refers to processing devices in general, including, for example, a computer, a microprocessor, an integrated circuit, or a programmable logic device. Processors also include communication devices, for example, computers, cell phones, portable/personal digital assistants (“PDAs”), and other devices that facilitate communication of information between end-users.

Reference to “one embodiment” or “an embodiment” or “one implementation” or “an implementation”, as well as other variations thereof, means that a particular feature, structure, characteristic, and so forth described in connection with the embodiment is included in at least one embodiment. Thus, the appearances of the phrase “in one embodiment” or “in an embodiment” or “in one implementation” or “in an implementation”, as well any other variations, appearing in various places throughout this application are not necessarily all referring to the same embodiment.

Additionally, this application may refer to “determining” various pieces of information. Determining the information may include one or more of, for example, estimating the information, calculating the information, predicting the information, or retrieving the information from memory.

Further, this application may refer to “accessing” various pieces of information. Accessing the information may include one or more of, for example, receiving the information, retrieving the information (for example, from memory), storing the information, moving the information, copying the information, calculating the information, determining the information, predicting the information, or estimating the information.

Additionally, this application may refer to “receiving” various pieces of information. Receiving is, as with “accessing”, intended to be a broad term. Receiving the information may include one or more of, for example, accessing the information, or retrieving the information (for example, from memory). Further, “receiving” is typically involved, in one way or another, during operations, for example, storing the information, processing the information, transmitting the information, moving the information, copying the information, erasing the information, calculating the information, determining the information, predicting the information, or estimating the information.

It is to be appreciated that the use of any of the following “/”, “and/or”, and “at least one of”, for example, in the cases of “A/B”, “A and/or B” and “at least one of A and B”, is intended to encompass the selection of the first listed option (A) only, or the selection of the second listed option (B) only, or the selection of both options (A and B). As a further example, in the cases of “A, B, and/or C” and “at least one of A, B, and C”, such phrasing is intended to encompass the selection of the first listed option (A) only, or the selection of the second listed option (B) only, or the selection of the third listed option (C) only, or the selection of the first and the second listed options (A and B) only, or the selection of the first and third listed options (A and C) only, or the selection of the second and third listed options (B and C) only, or the selection of all three options (A and B and C). This may be extended, as is clear to one of ordinary skill in this and related arts, for as many items as are listed.

Also, as used herein, the word “signal” refers to, among other things, indicating something to a corresponding decoder. For example, in certain embodiments the encoder signals a quantization matrix for de-quantization. In this way, in an embodiment the same parameter is used at both the encoder side and the decoder side. Thus, for example, an encoder can transmit (explicit signaling) a particular parameter to the decoder so that the decoder can use the same particular parameter. Conversely, if the decoder already has the particular parameter as well as others, then signaling can be used without transmitting (implicit signaling) to simply allow the decoder to know and select the particular parameter. By avoiding transmission of any actual functions, a bit savings is realized in various embodiments. It is to be appreciated that signaling can be accomplished in a variety of ways. For example, one or more syntax elements, flags, and so forth are used to signal information to a corresponding decoder in various embodiments. While the preceding relates to the verb form of the word “signal”, the word “signal” can also be used herein as a noun.

As will be evident to one of ordinary skill in the art, implementations may produce a variety of signals formatted to carry information that may be, for example, stored or transmitted. The information may include, for example, instructions for performing a method, or data produced by one of the described implementations. For example, a signal may be formatted to carry the bitstream of a described embodiment. Such a signal may be formatted, for example, as an electromagnetic wave (for example, using a radio frequency portion of spectrum) or as a baseband signal. The formatting may include, for example, encoding a data stream and modulating a carrier with the encoded data stream. The information that the signal carries may be, for example, analog or digital information. The signal may be transmitted over a variety of different wired or wireless links, as is known. The signal may be stored on a processor-readable medium.

1. A method of video decoding, comprising:
obtaining a first set of data corresponding to a prediction block for a block of a picture;
obtaining a second set of data corresponding to decoded prediction residuals for said block of said picture;
adjusting said second set of data to form an adjusted second set of data, based on at least a blending parameter; and
combining said first set of data and said adjusted second set of data to form a decoded version of said block of said picture.

2. (canceled)

3. The method of claim 1, wherein said second set of data is scaled to form said adjusted second set of data.

4. (canceled)

5. The method of claim 1, wherein said first set of data is scaled when combining with said adjusted second set of data.

6-7. (canceled)

8. The method of claim 1, wherein said at least a blending parameter for adjusting said second set of data is constrained to an interval between 1−d and 1+d, wherein d depends on a quantization parameter for de-quantizing transform coefficients of said block.

9. The method of claim 1, wherein a value of a blending parameter for a prediction residual of a sample in said block depends on a value of a prediction for said sample.

10. (canceled)

11. The method of claim 1, wherein a same blending parameter is applied to blocks with a same quantization parameter.

12-13. (canceled)

14. The method of claim 1, further comprising:
clipping, in a transform domain, a value of a sample in a reconstructed version of said block to be between a lower bound and an upper bound, wherein said lower bound and said upper bound are based on a parameter indicating a quantization step for said block and a sum of a de-quantized transform coefficient and a transformed prediction for said sample.

15. An apparatus for video decoding, comprising one or more processors and at least one memory, wherein said one or more processors are configured to:
obtain a first set of data corresponding to a prediction block for a block of a picture;
obtain a second set of data corresponding to decoded prediction residuals for said block of said picture;
adjust said second set of data to form an adjusted second set of data, based on at least a blending parameter; and
combine said first set of data and said adjusted second set of data to form a decoded version of said block of said picture.

16. (canceled)

17. The apparatus of claim 15, wherein said second set of data is scaled to form said adjusted second set of data.

18. (canceled)

19. The apparatus of claim 15, wherein said first set of data is scaled when combining with said adjusted second set of data.

20-21. (canceled)

22. The apparatus of claim 15, wherein said at least a blending parameter for adjusting said second set of data is constrained to an interval between 1−d and 1+d, wherein d depends on a quantization parameter for de-quantizing transform coefficients of said block.

23. The apparatus of claim 15, wherein a value of a blending parameter for a prediction residual of a sample in said block depends on a value of a prediction for said sample.

24-25. (canceled)

26. A method of video encoding, comprising:
obtaining a first set of data corresponding to a prediction block for a block of a picture;
obtaining a second set of data corresponding to reconstructed prediction residuals for said block of said picture;
adjusting said second set of data to form an adjusted second set of data, based on at least a blending parameter; and
combining said first set of data and said adjusted second set of data to form a reconstructed version of said block of said picture.

27. The method of claim 26, wherein said second set of data is scaled to form said adjusted second set of data.

28. The method of claim 26, wherein said at least a blending parameter for adjusting said second set of data is constrained to an interval between 1−d and 1+d, wherein d depends on a quantization parameter for de-quantizing transform coefficients of said block.

29. The method of claim 26, wherein a value of a blending parameter for a prediction residual of a sample in said block depends on a value of a prediction for said sample.

30. An apparatus for video encoding, comprising one or more processors and at least one memory, wherein said one or more processors are configured to:
obtain a first set of data corresponding to a prediction block for a block of a picture;
obtain a second set of data corresponding to reconstructed prediction residuals for said block of said picture;
adjust said second set of data to form an adjusted second set of data, based on at least a blending parameter; and
combine said first set of data and said adjusted second set of data to form a reconstructed version of said block of said picture.

31. The apparatus of claim 30, wherein said second set of data is scaled to form said adjusted second set of data.

32. The apparatus of claim 30, wherein said at least a blending parameter for adjusting said second set of data is constrained to an interval between 1−d and 1+d, wherein d depends on a quantization parameter for de-quantizing transform coefficients of said block.

33. The apparatus of claim 30, wherein a value of a blending parameter for a prediction residual of a sample in said block depends on a value of a prediction for said sample.
